(19) United States
(12) Patent Application Publication
(10) Pub. No.: US 2002/0059531 A1
(43) Pub. Date: May 16, 2002

(54) Integrated tracking of multi-authentication among web services

(76) Inventor: Warren Kwan Lai On, Hong Kong (HK)

Correspondence Address: David S. Figatner, Esq., Clifford Chance Rogers & Wells LLP, 200 Park Avenue, New York, NY, 10166-0153, US

(21) Appl. No.: 09/825,405

(22) Filed: Apr. 3, 2001

Related U.S. Application Data
(60) Provisional application No. 60/249,399, filed on Nov. 16, 2000.

(51) Int. Cl. H04L 9/32; H04K 1/00; H04L 9/00

(52) U.S. Cl. 713/202; 713/182

(57) ABSTRACT

This invention presents a computerized method and system for sharing network authentication. The method includes receiving login information at an authentication site for a user logging into a first site. The login information includes an identification of the user. The login information is verified at the authentication site. A user session key and a second site's site key is transmitted to the verified user through the first site. The user session key and the second site's site key are generated at the authentication site. The user session key is received at the authentication site for the user logging into a second site. The user session key from the user is verified at the authentication site. The second site's site key is transmitted to the verified user through the second site.

### CROSS-REFERENCE TO RELATED APPLICATION

The present application claims the benefit of an earlier field U.S. Provisional Application Serial No. 06/249,399, which was filed on Nov. 16, 2000, and is titled “Integrated Tracking of Multi-Authentication Among Web Services.”

### BACKGROUND

Computer networks, and the Internet in particular, have changed the ways businesses and consumers communicate. The Internet has developed retail oriented portals, known as Business to Customer models (“B to C”), to improve communication and sales between businesses and consumers. Communications between businesses, known as business to business models (“B to B”), have also helped to improve the infrastructure of businesses. As the Internet continues to grow, however, there is an increasing sign that a hybrid model will eventually emerge. As businesses join forces to improve efficiency and cut costs, businesses may begin to target the same group of clients or share their client base. These models lay between B to B and B to C models.

One common problem these businesses have is deciding how to integrate their services in a seamless way. Many content providers such as news and financial portals may require subscriptions from customers in order to enjoy their services. Internet companies that sell merchandise to customers or businesses may require customers to sign in before placing an order. In these situations, users may be asked to input multiple (often all different) user identification and passwords in order to enjoy the different businesses' services. This can greatly reduce the effectiveness of a business partnership. It is generally not cost effective, however, to make a great effort to integrate all the business web sites together. This may not even be technically possible because of the proprietary web site technology of each business.

FIG. 1 demonstrates how users can currently connect to different network services provided by different vendors. The user 101 accesses the service of the first vendor 102 through a computer network 110 and then enters their user name and password 103. The user 101 can then access the service of a second vendor 105 through a computer network 110. To access the service of the second vendor 105, however, the user 101 must again enter its user name and password 104. The user 101 has no choice but to enter its user name and password twice, once for each of the vendor's login sessions even if the first vendor has a business partnership with the second vendor. Furthermore, the user name and password may be different from the user name and password entered for access to the service of the first vendor 102.

As competition grows, there may be a third vendor that offers the same services of both the first and second vendors. Users may drop the subscriptions for both the first and second vendors and subscribes to the third vendor because it offers the same level of services without the hassles of multiple logons.

The present invention addresses some of these problems.

### SUMMARY

The present invention provides a software system and method for user authentication among partnered service providers. This involves tracking a user's identity for all vendors sharing the same connection session. In this invention, a user can refer to the actual customer of the vendors or a computer process that requires authentication before transacting through partnered vendors.

In one aspect of this invention, a computerized method for sharing network authentication is presented. This method includes receiving login information at an authentication site for a user logging into a first site. The login information includes an identification of the user. The login information is verified at the authentication site. A user session key and a second site's site key is transmitted to the verified user through the first site. The user session key and the second site's site key are generated at the authentication site. The user session key is received at the authentication site for the user logging into a second site. The user session key from the user is verified at the authentication site. The second site's site key is transmitted to the verified user through the second site.

In another aspect of this invention, the login information, generated user session key, and generated second site's site key can be stored at the authentication site. The authentication site can be the first site. The identification of the user can include a user identification and a user password. The information of the user can include a user biometric. The verification of the login information can include comparing the login information to a stored login information at the authentication site.

In another aspect of this invention, a computer system for sharing network authentication is presented. The system includes a first computer, including a memory and a processor and executable software residing in the first computer memory. The software is operative with the first computer processor to receive login information from a user logging into the first computer. The login information can include an identification of the user. The software also transmits the login information to an authentication computer, which includes a memory and a processor. The software receives a user session key and a second site's site key from the authentication site. The software also transmit the user session key and the second site's site key to the user. The system also includes a second computer, which includes a memory and a processor and executable software residing in the second computer memory. The software is operative with the second computer processor to receive the user session key from the user logging into the second computer. The software transmits the user session key to the authentication computer. The software receives the second site's site a key from the authentication site. The software also transmits the second site's site key to the user. The system also includes executable software residing in the authentication computer memory. The software is operative with the authentication computer processor to receive the login information from the user logging into the first computer. The software also verifies the login information. The software transmits the user session key and the second site's site key to the first computer. The user session key and the second site's site key are generated at the authentication site. The software also receives the user session key from the user logging into the second computer. The software verifies the user session key and transmits the second site's site key to the second computer.

In another aspect, the first computer, second computer, and authentication computer can be connected via a computer communications network. The computer communications network can include an Internet or a network comprising a TCP/IP protocol.

The system can also include the system and method described above embodied in a digital data stream.

This invention may result in one or more of the following advantages. This invention can supply a single login session for the user even if the user enjoys subscribed services from multiple partnered vendors. Once a partnered vendor authenticates the user, the user does not have to enter login information to enter another partnered vendor. Partnered vendors can share user information and form alliances to draw more users to their web sites. The invention can help track user information to help the partnered vendors determine their user bases and potential user bases.

### DESCRIPTION OF THE DRAWINGS

FIG. 1 illustrates a user connecting to two different services via a network.

FIG. 2 illustrates a user connecting to two different services via a network that are using the user authentication invention.

FIG. 3 is a flowchart of the method for user authentication among partnered service providers.

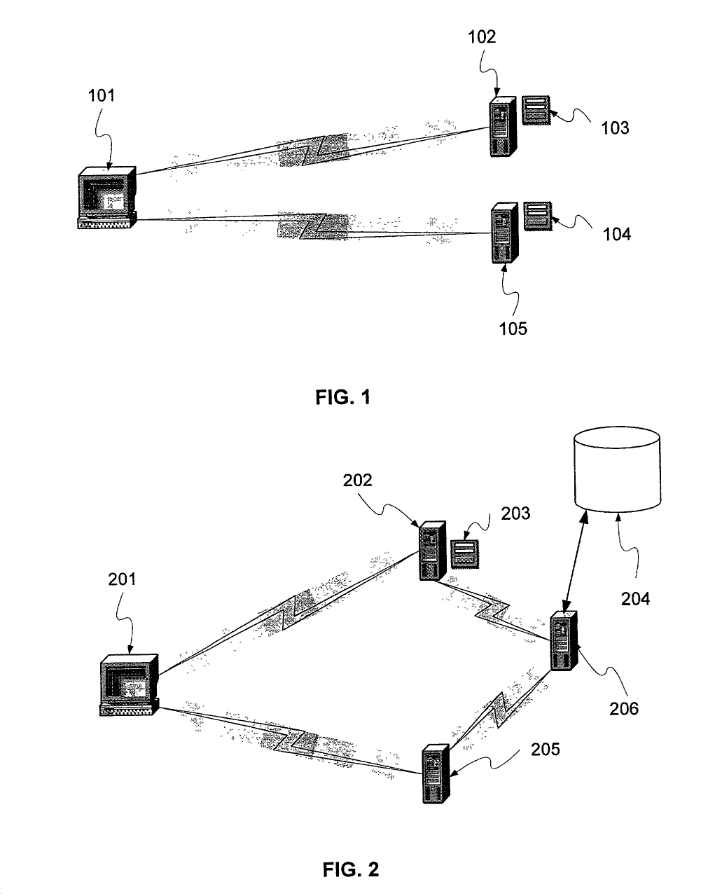

### DETAILED DESCRIPTION

The present invention provides a software system and method for user authentication among partnered service providers. This involves tracking a user's identity for all vendors sharing the same connection session. In this invention, a user can refer to the actual customer of the vendors or a computer process that requires authentication before transacting through partnered vendors.

In order to illustrate the concept of this invention, a simple configuration involving only two vendors who are providing services to the customers on a computer network is demonstrated. It should be understood that more than two vendors can be used by this invention to share user authentication.

FIG. 2 illustrates a typical configuration of a user and partnered vendors connected to a computer communications network, which can include a network using a TCP/IP interface designed to work with the Internet. The user 201 can connect to the first vendor 202 and the second vendor 205 through the computer communications network. The user 201 enters login information 203 when logging into the first vendor 202. The first vendor 202 and the second vendor 205 are connected to an authentication site 206 through the computer network. The authentication site 206 can be situated in the first vendor 202, the second vendor 203, or an independent location. The authentication site 206 can be connected to a database 204 that contains the user identification and login information. Other forms of data storage besides a database can also be used. The communications between the users, vendors, and authentication sites can commence through the use of web pages. Similarly, the communications can be sent through data signals over the communications network. The computer or computing device can have application software installed that allows it to access the computer network. For example, a standard Internet browser can allow the user to connect to the Internet through Java applets or Active X controls.

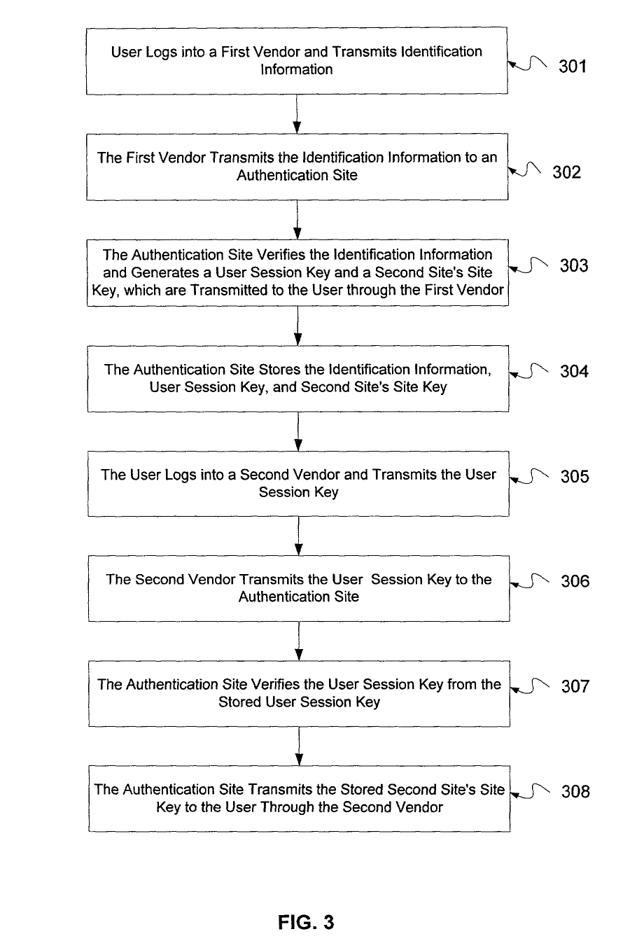

FIG. 3 illustrates a typical flow and sequence for a user logging into two partnered vendors. A user logs into a first vendor by transmitting identification information the first vendor 301. The identification information can include a user ID and a user password, a user biometric, or other types of information that can enable a user to be identified by a computer system.

The first vendor transmits the identification information to an authentication site 302. The authentication site verifies the identification information and generates a user session key and a second site key 303. The user session key can include the client's session key used by the client's browser or computer network software to identify the current session of the user. The user key can include any methods that can generate a unique ID associating the user's web session with the vendors. The user session key and the second site's site key are transmitted to the verified user through the first site 303. The user session key can be used by the first vendor to determine if the user is from the same or different session. In the case of a session disconnect, the first vendor can display to the user what it was browsing during its prior session using the user session key. This gives a sense of continuity without the user losing information acquired from the previous session.

To verify the user identification, the authentication site can compare the user identification information with stored information in a storage space, such as a database. The stored information can be encrypted in the storage space. The authentication site can store the identification information, user session key, and site key in a storage space, such as a database 304. The storage space can contain encrypted information. The user can then log into a partnered second site by transmitting its user session key 305 to the second site. The second site transmits the user session key to the authentication site 306 and the authentication site verifies the user session key by comparing it to the stored user session key 307. The authentication site then transmits the second site's site key to the verified user through the second site 308. The user can use the second site's site key to verify the correctness of the second site. In this way, the user can access partnered vendors during a common session by entering login information only once.

The pairing of session keys (e.g., the user and site keys) can be used to ensure that no sniffing is allowed and the user accesses the correct subscribed services from the correct vendors.

While this embodiment is shown from a two-vendor perspective, this invention can also be implemented with N vendors. To implement this scheme, pairings of n-1 site keys are needed, which are generated and transmitted to the user through the first site and used to verify the correctness of corresponding partner sites.

The first or second vendor can require that additional identification be entered before the transaction, such as a PIN number or a biometric; this invention will not prevent the vendor from adding the security measures to the vendor web site.

The computerized method for sharing network authentication can occur across three or more computers. Each computer can include a memory, a processor, and executable software residing in the computer memory. The software in the authentication site can be operative with the authentication processor to authenticate a user across partnered sites. The method includes receiving login information at the authentication site for a user logging into a first site. The login information can include an identification of the user. The authentication computer then verifies the login information and transmits a user session key and a second site's site key to the verified user through the first site. The user session key and the second site's site key are generated at the authentication site. When the authentication site receives the user session key from later sites, it verifies the user session key and transmits the second site's site key to the verified user through the second site. The user can verify the second site's site key to ensure the correctness of the second site.

A number of embodiments of the present invention have been described. Nevertheless, it will be understood that various modifications may be made without departing from the spirit and scope of the invention. For example, computers 102, 105, 202, 205, and 206 can include a personal computer executing an operating system such as Microsoft Windows™, Unix™, or Apple Mac OS™, as well as software applications, such as a web browser. Computers 102, 105, 202, 205, and 206 can also be terminal devices, smart phones, a palm-type computer WEB access device that adhere to a point-to-point or network communication protocol such as the Internet protocol. Other examples can include TV WEB browsers, terminals, and wireless access devices (such as a Palm OS™ organizer). The computers 102, 105, 202, 205, and 206 may include a processor, RAM and/or ROM memory, a display capability, an input device and hard disk or other relatively permanent storage. Accordingly, other embodiments are within the scope of the following claims.

What is claimed is:

1. A computerized method for sharing network authentication comprising:
receiving login information at an authentication site for a user logging into a first site, wherein the login information comprises an identification of the user;
verifying the login information at the authentication site;
transmitting a user session key and a second site's site key to the verified user through the first site, wherein the user session key and the second site's site key are generated at the authentication site;
receiving the user session key at the authentication site for the user logging into a second site;
verifying the user session key from the user at the authentication site; and
transmitting the second site's site key to the verified user through the second site.

2. The method of claim 1, additionally comprising storing the login information, generated user session key, and generated second site's site key at the authentication site.

3. The method of claim 1, wherein the authentication site comprises the first site.

4. The method of claim 1, wherein the identification of the user comprises a user identification and a user password.

5. The method of claim 1 wherein the information of the user comprises a user biometric.

6. The method of claim 1 wherein the verification of the login information comprises comparing the login information to a stored login information at the authentication site.

7. A computer system for sharing network authentication comprising:
a first computer, wherein the first computer comprises a memory and a processor;
executable software residing in the first computer memory, wherein the software is operative with the first computer processor to:
receive login information from a user logging into the first computer, wherein the login information comprises an identification of the user;
transmit the login information to an authentication computer, wherein the authentication computer comprises a memory and a processor;
receive a user session key and a second site's site key from the authentication site; and
transmit the user session key and the second site's site key to the user;
a second computer, wherein the second computer comprises a memory and a processor;
executable software residing in the second computer memory, wherein the software is operative with the second computer processor to:
receive the user session key from the user logging into the second computer;
transmit the user session key to the authentication computer;
receive the second site's site a key from the authentication site; and
transmit the second site's site key to the user; and
executable software residing in the authentication computer memory, wherein the software is operative with the authentication computer processor to:
receive the login information from the user logging into the first computer;
verify the login information;
transmit the user session key and the second site's site key to the first computer, wherein the user session key and the second site's site key are generated at the authentication site;
receive the user session key from the user logging into the second computer;
verify the user session key; and
transmit the second site's site key to the second computer.

8. The system of claim 7, wherein the first computer, second computer, and authentication computer are connected via a computer communications network.

9. The system of claim 8, wherein the computer communications network comprises an Internet.

10. The system of claim 8, wherein the computer communications network comprises a network comprising a TCP/IP protocol.

11. A computer system for sharing network authentication comprising:
an authentication computer, wherein the computer comprises a memory and a processor; and
executable software residing in the computer memory wherein the software is operative with the processor to:
receive login information at an authentication site for a user logging into a first site, wherein the login information comprises an identification of the user;
verify the login information at the authentication site;
transmit a user session key and a second site's site key to the verified user through the first site, wherein the user session key and the second site's site key are generated at the authentication site;
receive the user session key at the authentication site for the user logging into a second site;
verify the user session key from the user at the authentication site; and
transmit the second site's site key to the verified user through the second site.

12. A computer data signal embodied in a digital data stream for sharing network authentication, wherein the computer data signal is generated by a method comprising the steps of:
receiving login information at an authentication site for a user logging into a first site, wherein the login information comprises an identification of the user;
verifying the login information at the authentication site;
transmitting a user session key and a second site's site key to the verified user through the first site, wherein the user session key and the second site's site key are generated at the authentication site;
receiving the user session key at the authentication site for the user logging into a second site;
verifying the user session key from the user at the authentication site; and
transmitting the second site's site key to the verified user through the second site.
